(19) United States
(12) Patent Application Publication
(10) Pub. No.: US 2010/0131352 A1
(43) Pub. Date: May 27, 2010

(54) MOBILE AD OPTIMIZATION ARCHITECTURE

(75) Inventors: MANOJ MALHOTRA, Sunnyvale, CA (US); Sameer K. Merchant, Cupertino, CA (US); Adam T. Schuetz, East Palo Alto, CA (US)

Correspondence Address: HAYNES BEFFEL & WOLFELD LLP, P O BOX 366, HALF MOON BAY, CA, 94019, US

(73) Assignee: AdMarvel, Inc., San Mateo, CA (US)

(21) Appl. No.: 12/489,208

(22) Filed: Jun. 22, 2009

Related U.S. Application Data
(60) Provisional application No. 61/117,539, filed on Nov. 24, 2008.

(51) Int. Cl. G06Q 30/00

(52) U.S. Cl. 705/14.42; 705/14.43; 705/14.45; 705/14.66

(57) ABSTRACT

A method and system fulfills ad requests for delivery of ads to mobile clients in a mobile network. Ad data silos for ad requesters are maintained. The ad data silos are organized according to selected characteristics of the mobile clients of the ad requesters. In response to an incoming request for delivery of an ad, an attempt to fill the incoming request includes at least one of (1) retrieving an ad from a corresponding ad data silo to fulfill the incoming request, and (2) retrieving an ad according to a first priority policy from ad source among the plurality of ad sources to fulfill the incoming request. Also, in response to the incoming request, or other signals that may indicate current activity by the ad requester, an ad is retrieved according to a second priority policy for filling the corresponding ad data silo.

### CROSS-REFERENCE TO RELATED APPLICATION

This application claims the benefit of U.S. Provisional Application No. 61/117,539, entitled MOBILE AD OPTIMIZATION ARCHITECTURE, filed 24 Nov. 2008, which is incorporated by reference herein.

### BACKGROUND OF THE INVENTION

1. Field of the Invention

The present invention relates to management of the delivery of ads in a mobile network.

2. Description of Related Art

Advertisements have developed into a leading source of revenue for publishers of web pages. A network of ad sources is being developed to supply ads to publishers of web pages, capable of delivering up-to-date ads on demand. The basic framework for the delivery of ads is relatively complex, including advertisers which produce ads, ad sources which network with advertisers to deliver ads to publishers, publishers which display ads in their web pages, and intermediaries such as message aggregators and network service providers. When a consumer opens a web page, the publisher of the page generates a request for a current ad to be placed in the page from an ad source on the Internet. The advertisers contract with ad sources in this basic framework to deliver, for example, a specific ad, or set of ads, according to complex parameters, including for example, requiring delivery of an ad a specific number of times to customers having specific characteristics in time intervals before the ad becomes stale. Thus, the ad sources develop dynamically changing inventories of ads for delivery to publishers in a manner that seeks to fulfill the contracts with the advertisers. The publishers of web pages, in turn, contract with ad sources for the fulfillment of requests for ads generated when consumers view the publishers' pages. The publishers are paid by the ad sources or the advertisers for the delivery of advertisements to the consumers in a manner that results in actual impressions of the ad, that results in the consumer actually clicking through the ad to visit the advertiser's web page, which results in an actual revenue generating action by the consumer, and other metrics and combinations of metrics.

Under this basic framework, the revenue generation potential of specific ads, and of specific sources of ads used to fulfill requests, can vary with time. On the Internet, ad management tools, such as OpenX (See, OpenX 2.6 Users Guide, available for download at http://www.openx.org), have been developed to assist the publishers in the optimization of the selection of ad sources for revenue generation, by tracking impressions, click-through rate, revenue generation and so on by ad source, and using the tracking information to prioritize the ad sources used for fulfillment of ad requests.

In the mobile network, however, the basic framework is different and not as efficient. The content of the mobile web page is often formatted for a different, smaller display used on mobile network platforms, and coded using programming languages such as WAP and xHTML, that are adapted for the mobile network and platforms of the mobile network. We refer to the electronic documents used for rendering pages on a mobile network platform “mobile web pages” herein to distinguish over the standard Internet web pages designed for rendering on computers.

The efficiency of the mobile network is reduced because the bandwidth is much less than is typical in desktop or laptop use of the Internet. Also, the consumer of a mobile web page in the mobile network often visits a specific site for a shorter period of time than does the typical Internet user in the broadband network. So the ad latency, that is, the amount of time between the consumers opening of a mobile web page by a publisher and the delivery of an impression of the ad to the consumer on the mobile platform, becomes a critical factor in revenue generation. If the latency for fulfilling an ad is too long, then a publisher may miss a revenue opportunity altogether as a consumer moves on. The ad latency increases each time a request for an ad from an ad source is unsuccessful, and an additional request for the ad must then be made. As a result, the typical fill rate of the ad source, that is the probability of getting a useful ad from the ad source, can be a determining factor of the ad latency. So, in the mobile network, publishers have sought to use ad sources that provide the highest fill rates in responding to requests for ads in an attempt to obtain the lowest latency.

Low latency however is only one factor in ad revenue generation. Ad quality, ad relevance, ad revenue potential, and historical ad performance all vary dynamically. The highest fill rate ad sources may have poorly performing ad content available at a given time, such that it would be desirable to pull ads from a different, more relevant ad source. Therefore, in the mobile network, the potential for generation of revenue for advertisements is limited by technological limitations in the system that are determinate of latency for delivery of ads.

In existing systems, ad latency and ad fill rates for multiple ad networks are balanced to some degree using a daisy chain approach. Basically, when a publisher requests delivery of an ad, it goes to a first ad network with an attempt to fill the ad. If the first ad network does not fulfill the ad, then the publisher goes to a second ad network, and so on until the ad is fulfilled. The serial approach works well when the ads are normally fulfilled in the first one or two steps in the chain. However, the process favors low latency ad networks over others, and can result in the delivery of more low quality ads to the publisher, because of the relative strengths of the ad delivery systems deployed by the ad networks. This results in lower revenue for the publisher than might be achieved with prompt delivery of higher quality ads.

The efficiency is further limited by privacy concerns that prevent a publisher or wireless carrier from sharing information about its customers with the ad networks who supply the ads. Thus, the ad networks cannot process the requests individually, based on preferences or characteristics of a known consumer.

It is desirable to provide improved systems for management of the delivery of ads to publishers in the mobile network environment.

### SUMMARY OF THE INVENTION

A method executed by an ad manager implemented using network server technology for fulfilling ad requests for delivery of ads from a plurality of ad sources to mobile clients and a mobile network is set forth herein. The method comprises maintaining ad data silos for ad requesters, such as the publishers of mobile web pages or SMS messages for delivery to mobile clients. The ad data silos are organized according to selected characteristics of the mobile clients of the ad requesters. In response to an incoming request from an ad requester for delivery of an ad, the process attempts to fulfill the incoming request by performing at least one of (1) retrieving an ad from a corresponding data silo to fulfill the incoming request, and (2) retrieving an ad according to a first priority policy from an ad source among the plurality of ad sources, via the Internet or other communications network, to fulfill the incoming request. Also, the method includes retrieving an ad according to a second priority policy in response to the incoming request, or other signals predictive of a request for an ad from a requester matching the characteristics of a data silo, from an ad source among the plurality of ad sources to store in the corresponding ad data silo. The first and second priority policies are different. The first priority policy is adapted for serving ads in the condition that there is no ad present in the corresponding ad data silo for the requester, imposing for example a preference for ad sources having a better fill rate performance to provide a higher probability of a successful, timely delivery of an ad to the mobile client. The second priority policy is adapted for retrieving ads to fill the ad data silo for the requester with ads having better performance in delivering value to the requester to provide a higher probability of a revenue-generating ad being delivered to the mobile client from the corresponding silo. The first priority policy can address the technological differences among the ad sources, favoring those ads sources that have the infrastructure in place to quickly deliver ads. The second priority policy addresses content differences among the ad sources, favoring those ad sources which have higher quality ads in inventory at, or close to, the time of the ad request.

In embodiments of the technology described herein, attempts to fulfill the incoming request can include parsing the incoming request to identify characteristics of the mobile client associated with the incoming request, which in turn are used to identify the corresponding ad data silo. The corresponding ad data silo identified in this manner is walked to find a usable ad, which is returned to fulfill the request. Also, a first request for retrieval of an ad according to the first priority policy is composed and transmitted, to accommodate the condition in which no ad is found in the corresponding ad data silo, and can be transmitted if there is not, or alternatively independent of whether or not there is, a usable ad in the corresponding data silo. A response received based on the first request is returned to fulfill the request in the event that no usable ad is found in the corresponding silo. Also, a second request is composed for retrieval of an ad from an ad source selected according to the second priority policy. The second request can be transmitted before receiving the response to the first request, so that the processes of ad retrieval according to the first priority policy and ad retrieval according to the second priority policy overlap in time. An ad received in response to the second request is stored in the corresponding ad data silo.

An ad manager as described herein also tracks performance of ads returned in fulfillment of the incoming requests. At least the second priority policy, and preferably both the first and second priority policies, is/are updated from time to time based on the performance, in order to account for changes in the inventory of ads provided by the various publishers, and other dynamic factors that can affect the probability of receiving an income producing ad in response to a given request.

Also, embodiments of an ad manager as described herein manage the freshness of ads stored in the ad data silos for the corresponding ad requesters. Thus, ads are tagged with timestamps and discarded when they have been present in the ad data silo for more than a designated period of time. This process is executed in order to ensure that the inventory of ads present in the silo corresponds closely with current inventory being delivered by the ad sources.

In order to facilitate performance tracking, embodiments of the process instrument ads delivered through the ad manager for this purpose, such as by replacing links to advertiser websites with specialized links to a performance monitor accessible by the ad manager, or other links or code that allow tracking of the performance by the ads.

Also, embodiments of the ad manager provide software modules to ad requesters which are executed to configure ad requests with parameters for identifying the corresponding silos. The silos can be set up in cooperation between the ad manager and the ad requesters to establish a desired level of granularity in the management of the ad data silos for the ad requesters. Information needed for identifying a corresponding ad data silo can be mined by the requester from protocol headers, data fields, demographic databases and so on, configured using a software module provided by the ad manager.

In addition, a data processing system is described which includes the resources to carry out the processes described above.

Furthermore, resources for executing the processes described above including computer programs executable to perform the processes described above, and stored on machine readable data storage media, can be provided as described herein.

Other aspects and advantages of the present invention can be seen on review of the drawings, the detailed description and the claims, which follow.

### BRIEF DESCRIPTION OF THE DRAWINGS

FIG. 1 is a contextual diagram illustrating a network environment including an optimized ad server as described herein.

FIG. 2 is a network diagram showing parallel paths for ad retrieval using an ad manager as described herein.

FIG. 3 is a diagram of data structures, including ad requests and publisher ad data silos, utilized in a process as described herein.

FIG. 4 is a diagram of a software architecture for an ad manager as described herein.

FIG. 5 is a block diagram of a data processing system configured to execute the processes described herein, including machine readable media storing computer programs for this purpose.

FIG. 6 is a flowchart of a process for retrieving an ad using an ad manager as described herein.

FIG. 6A is a flowchart showing a modification of the process of FIG. 6, for retrieving two ads for one mobile web page using an ad manager as described herein.

FIG. 6B is a flowchart showing a modification of the process of FIG. 6, for managing ad silo fill requests based on a probability that a subsequent ad request will be made, using an ad manager as described herein.

FIG. 7 is a flowchart illustrating an iterative process of attempting to retrieve an ad according to a first priority policy.

FIG. 8 is a flowchart illustrating an iterative process of attempting to retrieve an ad for placement in a corresponding ad data silo according to a second priority policy.

FIG. 9 is a simplified diagram of a server architecture with a load balancer for performing the ad manager functions described herein.

FIG. 10 is a flowchart illustrating a process for walking an ad data silo in an environment including multiple delivery boxes such as that shown in FIG. 9.

### DETAILED DESCRIPTION

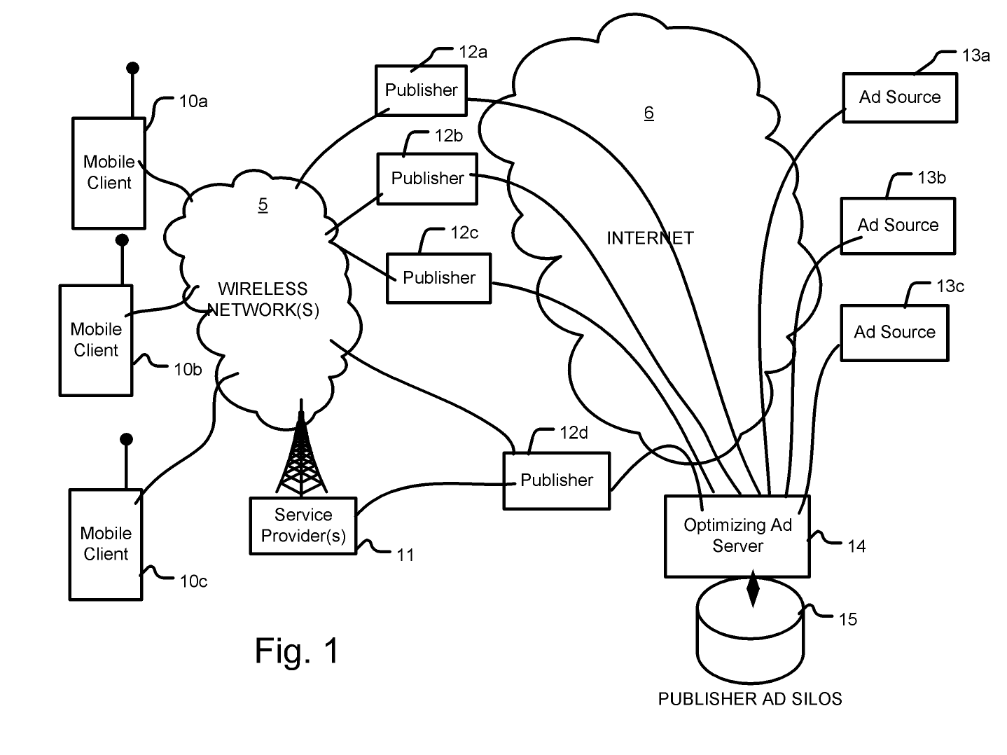

A detailed description of embodiments of the present invention is provided with reference to the FIGS. 1-10.

FIG. 1 is a contextual diagram illustrating a network environment including an optimizing ad server 14, which for example is implemented by executing processes in a network server system with data processing resources, including processing units, memory, communication interfaces and so on, along with mulitprotocol network communication resources typical of Internet server systems. The network environment includes wireless networks 5 and the broader Internet 6. The wireless networks 5 are characterized by having protocols, at least at the physical layer, which are adapted for wireless networks such as the mobile telephone networks. Higher layer protocols which are executed in wireless networks include, for example, the industry-standard Simple Message Service SMS and industry-standard Wireless Access Protocol WAP. The Internet 6 is characterized by a broadband backbone bringing together a wide variety of network protocols. A plurality of mobile clients 10a-10c participate in wireless networks 5, which are maintained by one or more service providers 11. The mobile clients 10a-10c include resources for accessing and displaying mobile web pages, SMS messages and/or other content from a plurality of publishers 12a-12d that also participate in wireless networks 5. Mobile clients can include mobile network browsers on cell phones, and on related platforms such as the popular iTouch platform provided by Apple Computer, that access the same mobile network and use similar browsing platforms. Also, mobile clients can include application programs running on such platforms that include displays with embedded ads retrieved using the mobile network. Ads retrieved in the ways described here can be displayed on mobile web pages, on idle screens on cell phones, in application display screens, in SMS and MMS messages and so on.

The publishers 12a-12d are coupled to the wireless networks 5 using gateways and/or servers which also provide access to the broader Internet 6. In the illustrated environment, the publisher 12d is coupled directly to a service provider 11, which provides the gateway or server for access to the wireless networks 5 as well as access to information about clients of the service provider. Mobile clients 10a-10c communicate with the publishers 12a-12d using drivers that communicate using message structures compliant with the protocols supported in the network, such as SMS and WAP as mentioned above.

When one of the mobile clients 10a-10c accesses a website or other application provided by one of the publishers 12a-12d in this environment, the publisher retrieves an ad from one of a plurality of ad sources 13a-13c that are coupled to the Internet 6 or otherwise accessible by the publisher. This process involves a request to fulfill an ad from one or more of the ad sources 13a-13c, which returns a current ad from hopefully a fresh inventory. Typically the mobile web page is delivered to the client first, with a placeholder for the ad. Alternatively, the publisher can forward an ad with the other content of the mobile web page to the client. In any event, when the ad is retrieved by the publisher, it is forwarded to the client and inserted in the mobile web page as the page is viewed by the client.

Using technology described herein, the publishers 12a-12d direct their requests for ads to an optimizing ad server 14, which maintains ad data silos 15 in cooperation with the publishers 12a-12d. The optimizing ad server 14 acts as an ad manager with parallel priority engines. It includes data processing resources, such as a computer system with suitable computer programs like those commonly used in network servers, which in response to an incoming request from an ad requester such as one of the publishers 12a-12d, attempt to fulfill the incoming request by performing at least one of (1) retrieving an ad from the corresponding ad data silo (among silos 15) to fulfill the incoming request, and (2) retrieving an ad according to a first priority policy from an ad source among the plurality of ad sources associated with the ad requester to fulfill the incoming request. Also, in response to the incoming request or other signals that might be generated and detected by the ad manager predictive of an ad request by an ad requester that matches a particular silo, the optimizing ad server 14 includes data processing resources that (3) retrieve an ad according to a second priority policy from an ad source among the plurality of ad sources that is stored in the silo (among silos 15) associated with the ad requester. The silos 15 are maintained for the ad requesters in the form of a database or set of data files associated with the ad requesters, in memory accessible to the server 14, holding ads that can be used to fulfill requests for ads.

The acts of retrieving ads according to the first and second priority policies can be executed in parallel, such that the set of communications involved in retrieval of an ad according to the first priority policy for delivery to the mobile client overlaps in time with the set of communications involved in retrieval of an ad according to the second priority policy for storage in the silo. Also, the process of choosing an ad according to the first priority policy can be independent of the process of choosing an ad according to the second priority policy.

In the embodiment of FIG. 1 the optimizing ad server 14 communicates with a plurality of publishers 12 via the Internet 6. Alternatively, the optimizing ad server 14 is not shared among each of the publishers 12a-12d, and some or all of the publishers 12a-12d communicate with dedicated optimizing ad servers.

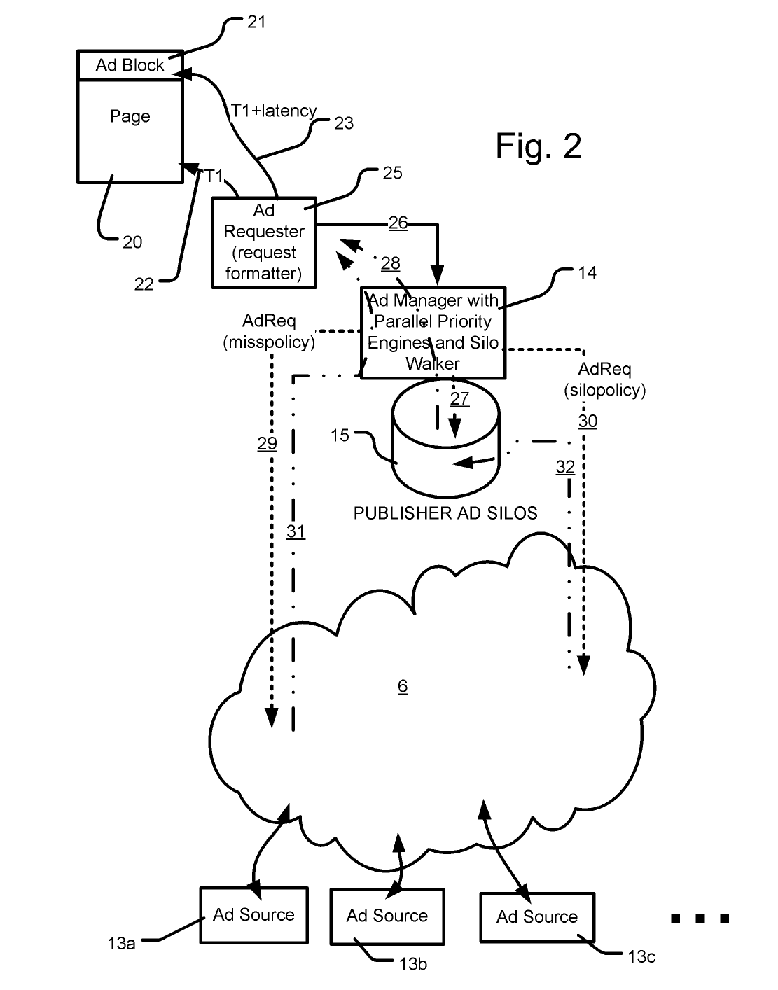

FIG. 2 illustrates a process of fulfilling a request for an ad from an ad requester 25 (e.g. publishers 12a-12d in FIG. 1) for delivery to a mobile device displaying mobile web page 20 having an ad block 21 or other placeholder on the mobile web page 20 for displaying an ad. The arrow 22 in FIG. 2 represents a time T1 for delivery of the mobile web page 20 from a publisher, and the arrow 23 represents a time T1+latency, where the latency represents the difference in time between delivery of the mobile web page 20 and delivery of an ad for display in the ad block 21 on the mobile web page 20. In the illustrated embodiment, the ad requester 25 includes a request formatter, which formats a request for an ad in a manner that identifies characteristics, configured by the ad manager in cooperation with the publisher, used to select an ad data silo that can be used in fulfillment of the request. The formatted request is forwarded as represented by the arrow 26 to the ad server 14. The ad server 14 attempts to fulfill the ad request by accessing the corresponding ad data silo as represented by arrow 27. If there is a suitable ad available in the silo 15, then the ad is returned as represented by arrow 28 to the mobile client for fulfilling the ad block 21, such as by returning it to the ad requester 25 which then forwards the content to the mobile client. If there is not a suitable ad available in the silo 15, then the ad manager attempts to fulfill the ad request by communicating with one of a plurality of ad sources 13a-13c according to a first priority policy as represented by arrow 29.

Whether or not there is a suitable ad available in the silo 15, the ad server 14 composes an ad request according to the second priority policy as represented by arrow 30, and forwards the second ad request to one of the plurality of ad sources 13a-13c. The request represented by arrow 29 can be independent of the request represented by arrow 30.

A response represented by arrow 31 is returned to fulfill the request represented by arrow 29 via the ad server 14. If the response represented by arrow 31 contains a viable ad, then it is forwarded to the mobile client for fulfilling the ad block 21.

A response represented by arrow 32 is returned to fulfill the request represented by arrow 30, and if it contains a viable ad, the ad is placed in the ad data silo 15 identified by the requester.

The first priority policy is adapted for the condition in which the mobile client is likely viewing the mobile web page in which the ad is intended to be displayed, and which therefore can place high emphasis on latency. In the mobile setting, latency can be critical because of the chance that the mobile client will move on to a different web page without receiving an impression of an ad, and without any opportunity for revenue for the advertiser. Latency is often a technological issue, which can be managed by the ad sources using sophisticated network tools to increase their fill rate, leading to advantages by certain ad sources that are not related to the content of the ads in their inventory.

The second priority policy is adapted for the condition in which the mobile client is likely to take an action that results in a second ad request via the same ad requester 25. Therefore, the second priority policy can place emphasis on factors focused less on latency and the fill rate of the ad sources, and more on the content of the ads, which is more determinative of the ability of a specific ad to provide financial return to the publisher.

The combination of the first and second priority policies, with the use of the ad data silos, provides for delivery of ads with lowest available latency during the first part of a session with a mobile client, and for delivery of better quality ads with low latency in a later part of the session with the mobile client, improving the effectiveness of advertisements presented by the publisher.

The priority engines within the ad server 14 can adaptively maintain respective policies based on performance metrics for the ad sources, such as average fill rate for returning a viable ad, click-through rate CTR, cost per thousand CPM, effective cost per thousand eCPM, load balancing parameters among ad sources, and so on. The ad server 14 in preferred systems includes a performance metric measurement module, which gathers statistics concerning the performance of ads and applies the statistics in dynamically maintaining by, for example, periodically updating the first and second policies used by the parallel priority engines. Examples of dynamically maintaining the first and second priority policies include updating the policies at regular intervals, at times that changes in the relative performance of ad sources occur, or at times that coincide with other ad source events. Other ad source events that could be taken into account in the updating of the policies include, for example, times at which ad libraries at the various ad sources are updated with fresh ads, and peak publishing periods. Also, per user activity can be monitored to develop information that is predictive of ad requests, such as the average amount of time spent by a user with a particular mobile web page or family of linked pages and the number of ad requests typically issued per session accessing a particular mobile web page.

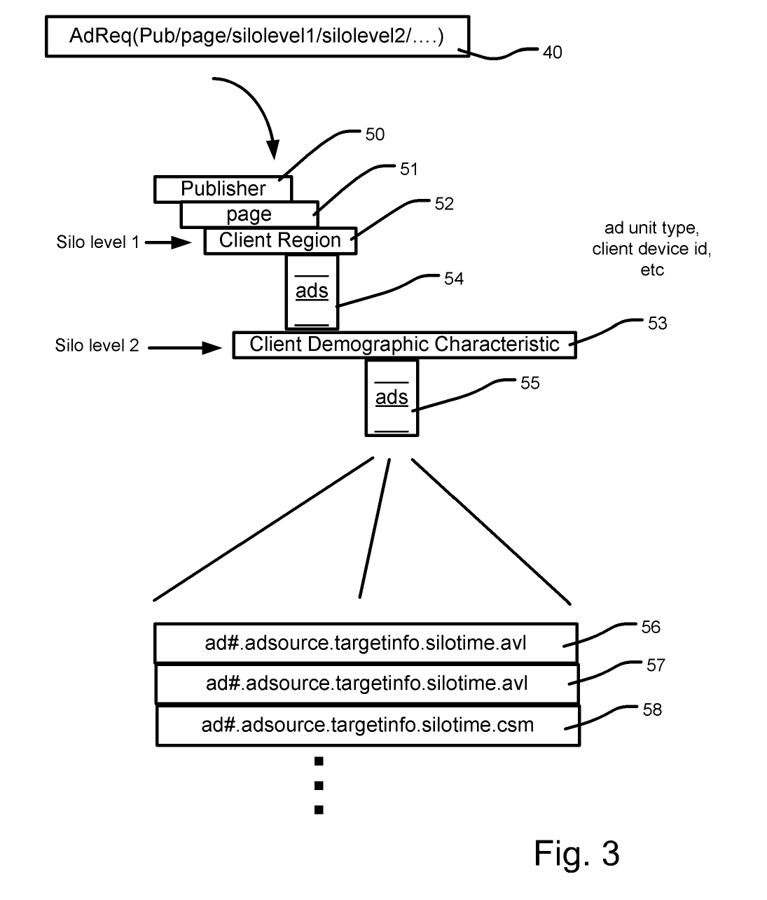

FIG. 3 is a simplified diagram of data structures utilized in a system like that shown in FIG. 2. The data structures include an ad request 40, a publisher silo which in this example is a simple directory structure including directory levels 50-53 and sets 54, 55 of files that contain ads. The files within the sets of files (e.g. set 55) have filenames 56, 57, 58 that can carry identifying information as well.

The ad request 40 is formatted by an ad requester to carry information needed to identify the corresponding publisher's ad data silo, represented in the figure by (Pub/page/silolevel1/silolevel2/ . . . ). Thus, the requester formats a request 40 that identifies the publisher, the page being displayed by the publisher, and the characteristics of the event used to select an ad, identified as silo levels in this diagram. The information used in formatting the ad request can be derived from headers and other fields present in the data packets received from the mobile client, and from demographic data maintained about specific clients either by the publisher itself or by a service provider having a contract with the publisher. Such information as geographic areas, identifiers of mobile devices, Internet protocol addresses, categories of mobile devices, geographic positioning system data, and so on can be utilized for specifying publisher ad data silos.

In the example shown, the silo comprises a directory tree with a top level 50 labeled with an identifier of the publisher, a second level 51 labeled with an identifier of the mobile web page being presented, a third level 52 labeled with an identifier of the region in which the client mobile device is detected at the time of the request and corresponding with silolevel1 in the request, a fourth level 53 labeled with a different demographic characteristic of the client, and so on. Various levels can be identified by the type of the mobile device being used, types of advertisements to be displayed, age of the user, gender of the user, and so on. In some embodiments, a silo level can correspond with a unique Internet protocol address or set of addresses for the mobile client, or a unique identifier of the mobile unit. In embodiments in which a user or mobile client can be uniquely identified in an ad request, the ad silo data structure is maintained on a per user or per client basis for the publisher. In this case, in systems serving multiple publishers, silos have two levels with the first level identifying the publisher and the second level carrying the unique identifier. Also, the silo can be organized by demographics which can be learned from cookies or other tracking information learned from a WAP header or phone number of the user viewing the published site. Also in SMS-based systems, the silo might be organized by area code, sub area code, request time, geography or other parameters useful for targeting advertisements.

In the example illustrated, sets 54 and 55 of files are associated with more than one level in the ad data silo, including set 54 associated with the client region 52 at silolevel1, and set 55 associated with the client demographic characteristic 53 at silolevel2. Also, the filenames used can carry additional information used to select ads for delivery in response to specific requests. For example, the filenames can be tagged with timestamps “silotime” that indicate the amount of time the ad has been resident in the silo. Alternatively, data for the timestamps can be stored within the files. Also, filenames can be tagged with the name “adsource” of the ad source, and other target information “targetinfo” that relates to characteristics of the mobile clients. In this example, the files have extensions that indicate whether the ad is available “avl”, or consumed “csm”, which can be used in an atomic operation for locking a file containing an ad during its processing to avoid multiple delivery mechanisms from reading the same ad.

The file system structure shown in FIG. 3 can be implemented in a variety of formats. Also, alternative ad data silo structures can be implemented using database technologies. The publisher silo is organized using a file system, in this example, including publisher-specific caches that key off a wide variety of information.

The publisher silos can be ephemeral, such that the silos are set up and taken down over relatively short intervals of inactivity by the mobile client (e.g. 10 minutes) that are relevant to the mobile ad serving experience. In this way, the silo memory management, along with maintenance of current advertisements within the silos, can be optimized.

The ad server 14 includes a program for walking the ad data silos to find viable ads for delivery in response to specific request. In embodiments in which sets of files can be associated with more than one level, then the program for walking the ad selects the first available ad closest to the leaf in the tree. Also, the ad server 14 will include a program for locking a file in the silo (e.g. by renaming the file extension) during processing to avoid competition for use of the same ad file by multiple processes being executed by the server. The ad manager also includes a program for detecting ads which have been present in the silo longer than a pre-specified interval to ensure that the ad remains fresh. In this environment, such intervals are often on the order of 3 to 5 minutes, but can vary as needed in a given network environment.

One issue associated with the use of ad silos as described here is the fact that some ads are retrieved and placed in the silos, but not used. This “throw-away” condition provides a level of inefficiency to the system that can be managed, at least to some extent. Throw-aways occur often when a user consumes a sequence of ads during a browsing session, resulting in a sequence of ad requests and a resulting sequence of silo fill requests, the last of which is likely to result in a throw-away silo fill. Performance data for a publisher's mobile web pages can be processed to predict the average number A of ad requests issued from users within a particular silo for a particular session. In this situation, the ad manager issues a silo fill request for the first N ad requests, and stops issuing silo fill requests thereafter, where the number N is based on the average number A, and can be less than, equal to, or greater than A depending on the performance data utilized.

Another issue associated with the use of ad silos and parallel ad retrieval processes arises in the case of mobile web pages that include two or more ads in different locations on the page, such as a banner ad at the top of the page and a line ad at the bottom of the page. In this case, it is important to prevent delivering ads from the same ad source to both locations. This can be done, by detecting requests for multi-ad pages, such as by formatting the ad requests at the publisher, and in response (for a two ad page) issuing two ad fill requests, where a first ad fill request assigns highest priority to one ad source and the second ad fill request assigns the highest priority to another ad source. One of the two ad requests can be fulfilled using the ad silo if possible, while the second of the two ad requests is made bypassing the ad silo. Also, the two ad request can be processed so that only one silo fill request is issued, or so that two silo fill requests are issued, in response to the two ad request. The use of only one ad fill request can prevent throw-aways in some conditions.

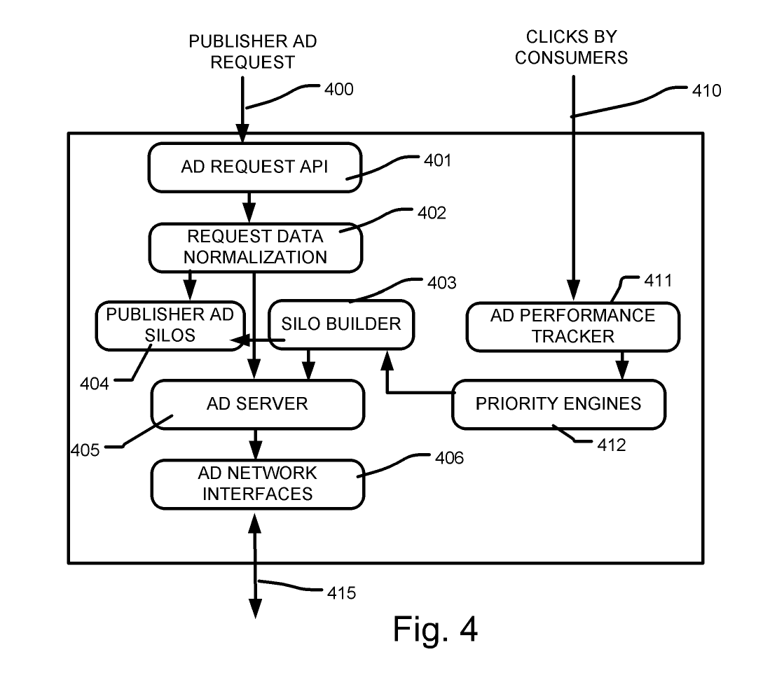

FIG. 4 illustrates a basic software architecture for an ad manager usable in systems described herein. Modules in the architecture include an ad request application program interface API 401, a request data normalization module 402, a publisher ad data silo builder module 403, publisher ad data silos 404, and ad server module 405 and added network interfaces 406. Also, ad performance tracker module 411 and priority engines 412 are included in the software architecture. A representative embodiment of components of these modules is set forth in the computer program appendix referred to above.

A request for an ad from a publisher is input on line 400. The ad request API 401 receives the input and provides data to the request data normalization module 402. The request data normalization module 402 identifies corresponding publisher ad data silos and initiates the parallel ad retrieval processes discussed above, using the silo builder module 403, the ad server module 405, and the ad network interfaces 406 which communicate with ad sources as indicated by arrow 415. The priority engines 412 used in parallel ad retrieval processes are managed using an ad performance tracker module 411. Inputs to the ad performance tracker module 411 include the click-throughs from consumers as indicated on line 410. Also, the performance tracker module 411 can count the instances in which a banner link from an ad that has been delivered, is sent back for fulfillment of image from client, as is used for detecting click track fraud techniques, as an indicator for consumption of an ad rather than or in addition to click-throughs. To simplify the drawing, return paths to the silos and the publishers are not shown in this figure. However, as can be appreciated, such paths are provided using the appropriate communication channels as indicated in FIG. 3.

A basic flow includes receipt of publisher requests at the ad request API 401. The request data normalization module 402 inspects the headers or message content in the ad request, and normalizes them to create a consistent view for further processing by the system. This includes normalizing the ad request time to Greenwich Mean Time GMT, extracting the IP address for the user's device, generating message related keywords, extracting cookie information and mapping the request to an ad data silo. As part of this process, the system may identify user parameters based on cookie recognition and mobile subscriber ID parameters for example. Next, the ad manager inspects the ads within the corresponding publisher ad data silo, which is adapted to contain a specialized cache of ads organized as described above. If an ad is present in the corresponding silo, the click-through link in the ad is instrumented for tracking, such as by replacing it with a link to the ad performance tracker 411, or combining the click-through link in the ad with an additional link to the ad performance tracker 411 or resources available to the ad performance tracker that can provide necessary data concerning click-through performance and other performance metrics. If an ad is not present, a request is made using the ad server 405 to the most preferred ad network according to a first priority policy that is designed in preferred systems to return an ad from an ad source that historically has had the best fill rate for that silo. If the highest priority ad network according to the first priority policy cannot fulfill the request, a retry counter is updated and the request is re-sent to a next ad network in sequence until all of the ad networks are tried or the request is serviced. The silo can be filled up to a prespecified parameter “n” requests looking forward, which can be on the order of 2 or 3 in a representative system. Simultaneously, a request is made to the silo builder 403 to start building up the corresponding silo. This silo builder 403 makes requests using the ad server 405 according to a second priority policy. If the highest priority ad network according to the second priority policy cannot fulfill the request, a retry counter is updated and the request is re-sent to a next ad network in sequence until all of the ad networks are tried or the request is serviced. The silo can be filled up to a prespecified parameter “n” requests looking forward, which can be on the order of 2 or 3 in a representative system.

As the system continues to serve ads, and users click on those ads, the ad performance tracker 411 builds historical trends for the corresponding silo in network metrics. Using these network metrics, the first and second priority policies are dynamically updated using the priority engines 412. The priority engines can use a sliding window algorithm for the first priority policy and the second priority policy to dynamically rank ad sources by performance corresponding to each silo and used by the silo builder 403 in maintaining the publisher ad data silos 404.

Embodiments of the system include a reporting tool associated with the ad performance tracker 411, for generating a wide range of performance reports for the publishers, including the following:
1. Dashboard: Ad serving metrics (requests, impressions, fill rates, clicks, banner image requests, click-through rate)
2. Aggregate revenue metrics (eCPM and total ad revenue)
3. Site level ad serving metrics
4. Site level revenue metrics
5. Aggregate Ad Network ad serving & revenue metrics
6. Individual Ad Network ad serving & revenue metrics (comparable side by side)
7. Discrepancy reporting (tracked clicks & impressions vs Ad Network reporting)
8. Site level Ad Network ad serving & ad revenue metrics
9. Device level ad serving and traffic metrics
10. Geographic level ad serving and traffic metrics

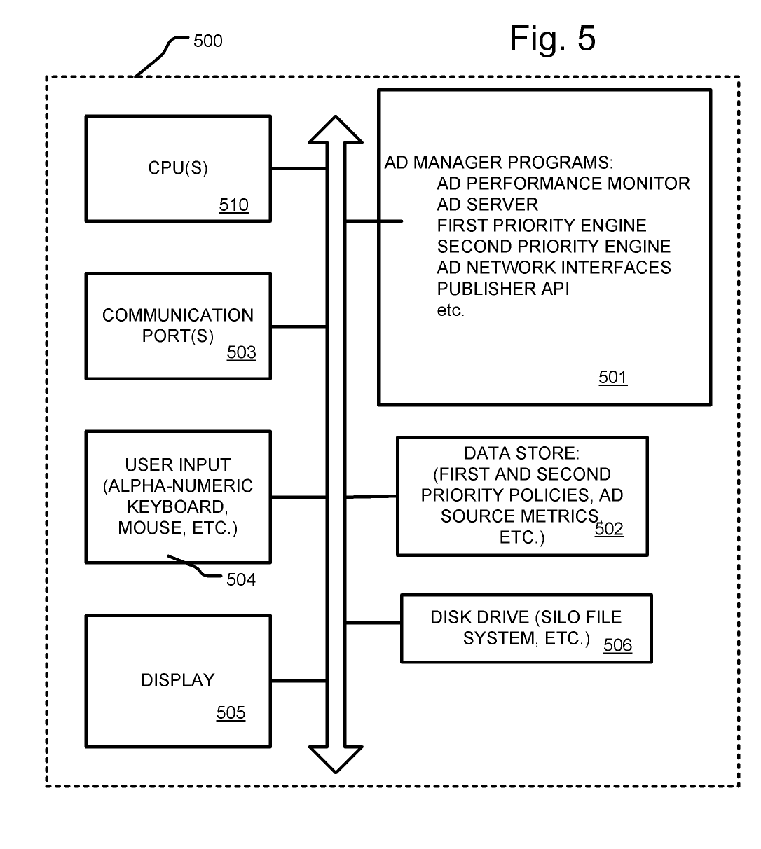

FIG. 5 is a simplified block diagram of a data processing system 500 arranged as an optimizing ad server with publisher silos, like server 14 and silos 15 shown in FIG. 1, and implementing the parallel priority engines as described herein. The system 500 includes one or more central processing units 510, which are arranged to execute computer programs stored in program memory 501, access a data store 502, access large-scale memory such as a disk drive 506, and to control communication ports 503, user input devices 504, and a display 505. Optimizing ad servers as represented by FIG. 5 include a single workstation, and networks of computers utilized by designers of Internet servers and gateways.

The data processing resources include logic implemented as computer programs stored in memory 501 for an exemplary system. In alternatives, the logic can be implemented using computer programs in local or distributed machines, and can be implemented in part using dedicated hardware or other data processing resources.

The data store 502 is typically used for storing machine-readable definitions of priority policies, performance metrics and so on. Large-scale memory, such as disk drive 506, is used to store databases and/or file systems, including the publisher ad data silos described above.

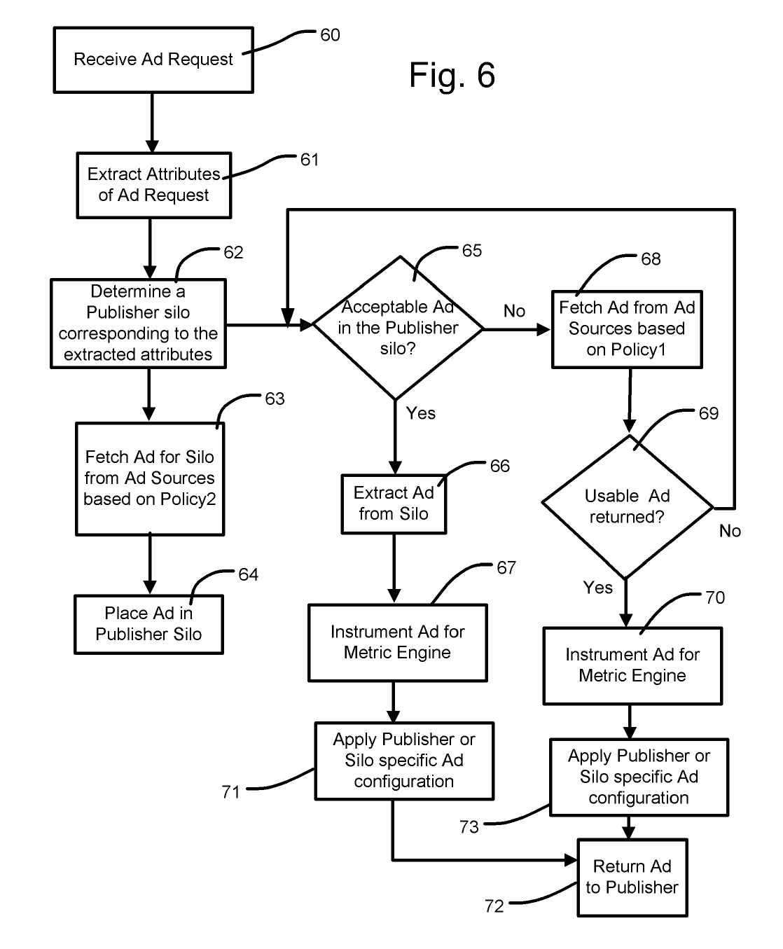

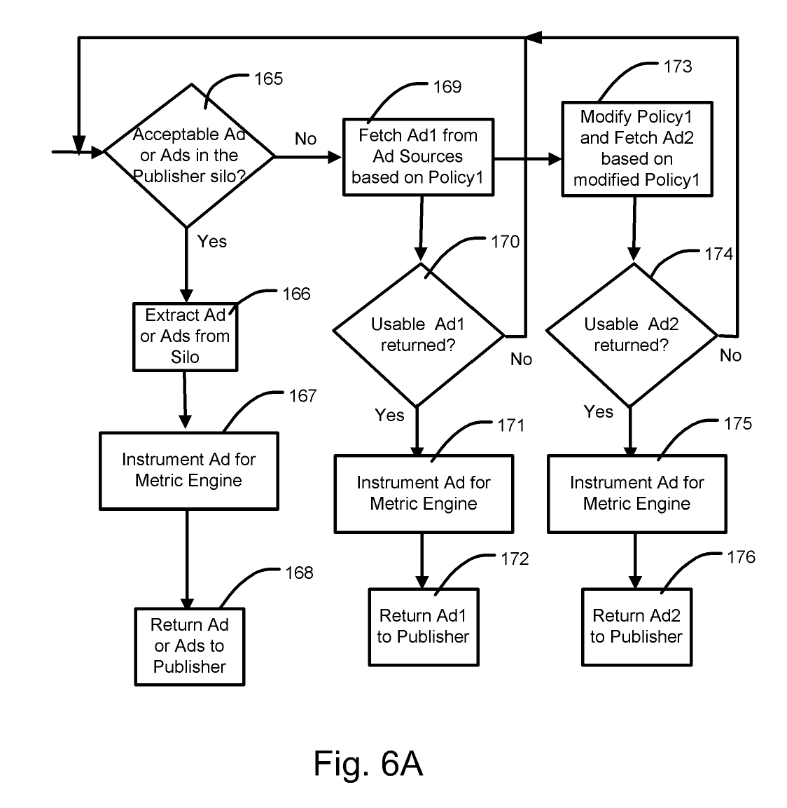

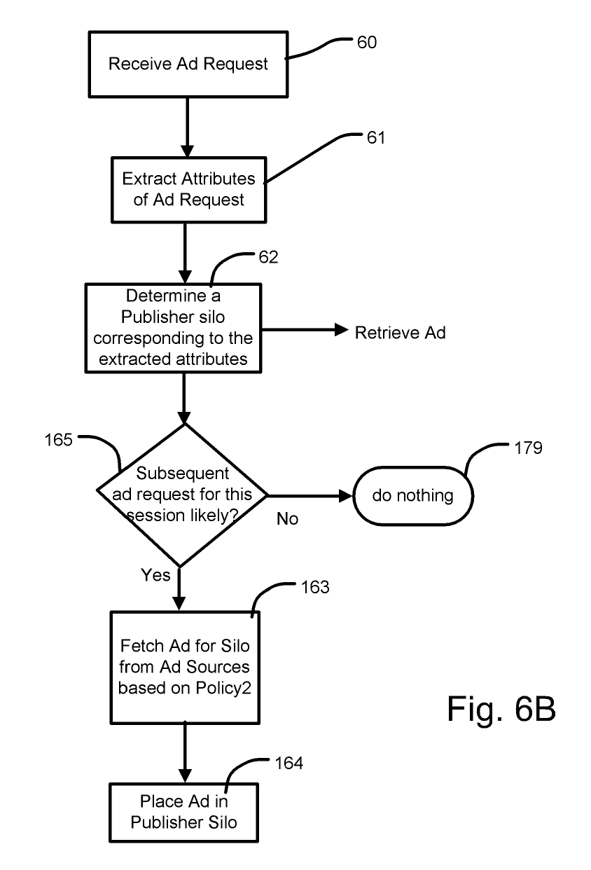

FIG. 6 is a simplified flowchart of a process executed by the ad server 14. The process begins with the receipt of an ad request (block 60). Next, the attributes of the ad request are extracted (block 61). A publisher silo corresponding to the extracted attributes of the ad request is identified (block 62). At this stage, independent and parallel processes are executed. One of the independent and parallel processes includes fetching an ad for the identified silo from the ad sources based on a priority policy (Policy2) adapted for silo filling (block 63), and placing a returned ad in the corresponding silo (block 64). The other of the independent and parallel processes includes determining whether an acceptable ad is present in the identified silo (block 65). If an acceptable ad is present, then the ad is extracted from the silo (block 66). In an embodiment that provides for local monitoring of performance metrics, the ad is instrumented for the metric engine by, for example, replacing or supplementing the links in the ad for click-thoughs connecting to a mobile web page published by the advertiser, and for banner image fulfillment messages, with links that direct the click-throughs to the ad metric engine running in the ad manager, which then redirects the click-though or banner image request to the mobile web page published by the advertiser or to the source of the banner image (block 67). Next, optionally, the extracted ad can be modified according to publisher or silo specific ad configuration information, such as by adapting the ad to a specific type or form factor of display, or converting the markup language of the ad to a publisher specified language (block 71). The ad is then returned for ultimate delivery to the mobile client (block 72). If an acceptable ad is not present at block 65, then an ad is fetched from the ad sources based on a priority policy (Policy1) adapted for example to accomplish low latency delivery of ads to the mobile client (block 68). The algorithm determines whether a usable ad is returned in response to the request (block 69). In an embodiment that provides for local monitoring of performance metrics, if a usable ad is returned, then the ad is instrumented for the metric engine (block 70). Next, optionally, the extracted ad can be modified according to publisher or silo specific ad configuration information (Block 73). Then the ad is provided for delivery to the mobile client (block 72). If a usable ad is not returned, then the process loops back to block 65 until an ad is provided for the mobile client. Alternatively, the process can simply retry fetching an ad from the ad source for one or two additional attempts for example, without first determining whether an ad has been loaded into the silo in the interim.

FIG. 6A shows one example modification of the flowchart of FIG. 6 after the step represented by block 62 of determining the publisher silo for the incoming request, in the case where there are two ads on a single mobile web page. In this case, steps are taken to prevent providing the same ad for both places on the mobile web page. The process begins by determining whether an acceptable ad (or optionally both ads) can be found in the publisher silo (block 165). If an acceptable ad is found, it is extracted from the ad silo (block 166). The ad is instrumented for the metric engine as explained above (Block 167). Finally, the ad is returned to the publisher (block 168). If at block 165, it is determined that at least one of the ads is not found in the silo, then the process is executed to fetch the first ad, or the ad which was not fulfilled from the silo, from ad sources based on the priority policy (Policy1) (block 169). If a second ad for the mobile web page is still needed, then the priority policy (Policy1) is modified by changing the weight of ad sources or otherwise, and a second process is executed to fetch the second ad from the ad sources based on the modified priority policy (block 173). As a result, the likelihood that the second ad is the same as the first ad is significantly reduced by causing the second ad to be retrieved most often from a different ad source than the first. After initiating a process to fetch an ad in block 169, the process waits for return of a usable ad (block 170). If a usable ad is returned from the first fetching process of block 169, then it is instrumented for a metric engine (block 171). Then it is returned to the publisher (block 172). After initiating a process to fetch an ad in block 173, the process waits for return of a usable ad (block 174). If a usable ad is not returned at block 174, then the process loops to block 165 and attempts to retrieve an ad from the silo once again. If a usable ad is returned from the first fetching process of block 173, then it is instrumented for a metric engine (block 175). Then it is returned to the publisher (block 176). If a usable ad is not returned at block 174, then the process loops to block 165 and attempts to retrieve an ad from the silo once again. The ad fetching process as represented by block 169 and 173 can be executed in a manner such that they overlap in time. Controls are implemented in the processes to prevent returning two ads for the same spot in the mobile web page.

FIG. 6B shows one example modification of the flowchart of FIG. 6 after the step represented by block 62 of determining the publisher silo for the incoming request useful to prevent throw-aways in the ad silos. At block 62, the process branches to retrieve the ad from the network, following the flow starting at block 65 of FIG. 6, and to perform ad silo fill processing in parallel. In the process of FIG. 6B, steps are taken to prevent making some silo fill requests which will result in ad throw-aways. Thus, the metric is maintained associated with the particular silo which indicates a number of ad requests, such as the average or the median number of ad requests which occur in sessions that use the silo. This metric is used to predict whether a subsequent ad request for the session is likely as shown at block 165. If a subsequent ad request is not likely, then no ad fill request is issued (block 179). If a subsequent ad request is likely according to this metric, then the process is executed to fetch an ad from the silo from the ad sources based on the silo fill policy (Policy2) (block 163). The ad returned is placed in the publisher silo (block 164).

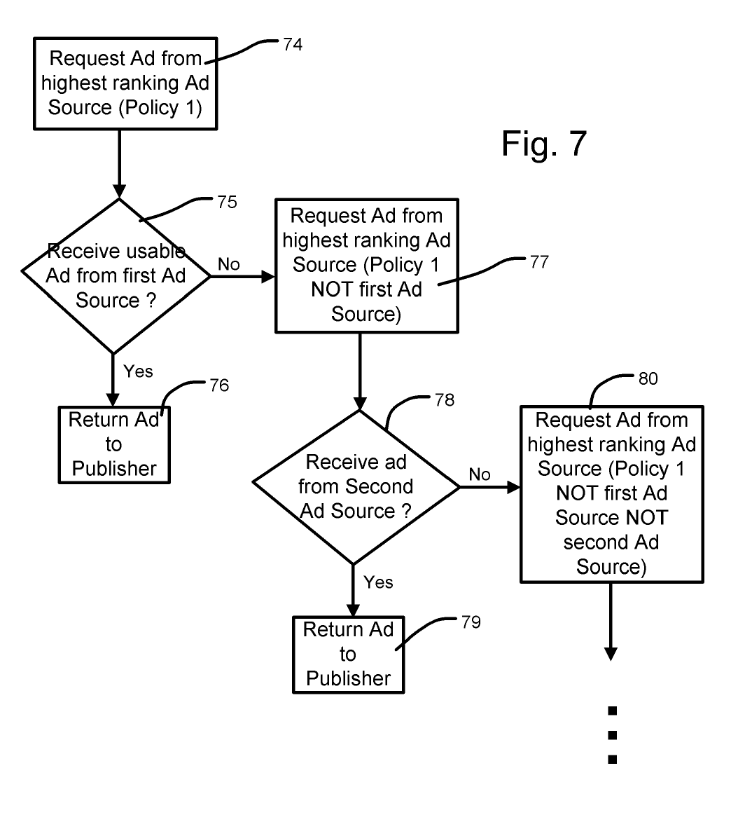

FIG. 7 illustrates an algorithm for obtaining a usable ad by a retry process, in an environment where an ad request to an ad source may not return a usable ad. In this process, corresponding for example to blocks 68 and 69 of FIG. 6, the ad manager requests an ad from the highest ranking ad source according to the priority policy Policy1 (block 74). Next, the process determines whether a usable ad has been delivered in response to the request (block 75). If a usable ad is returned, then it is delivered to the publisher (block 76). If a usable ad is not returned in the first attempt, then an ad is requested from the highest ranking ad source according to the priority policy Policy1, not including the first ad source (block 77). Here the “first ad source” is the source from which the ad was requested at block 74. Next, the process determines whether a usable ad has been delivered in response to the request (block 78). If a usable ad is returned, then it is delivered to the publisher (block 79). If a usable ad is not returned, then the process can repeat as indicated at block 80 for a specified number of times.

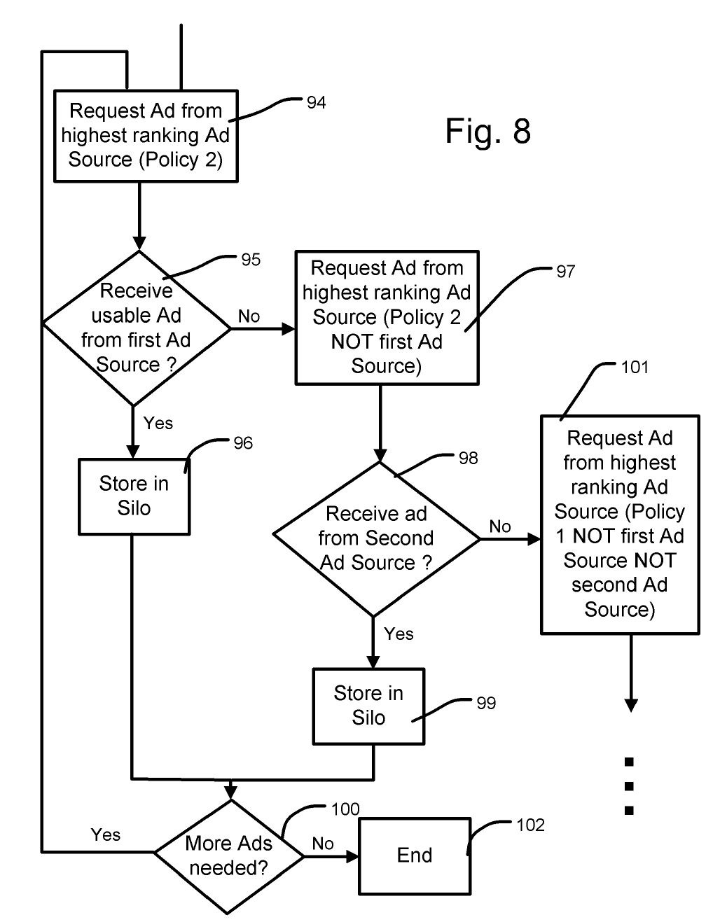

FIG. 8 illustrates an algorithm for obtaining an ad placed in the silo according to the second priority policy Policy2. In this process, the ad manager requests an ad from the highest ranking ad source according to the second priority policy (block 94). The process determines whether a usable ad is delivered in response to the request (block 95). If a usable ad is returned, then it is stored in the silo with the appropriate tags (block 96). If a usable ad is not returned, then the ad manager requests an ad from the highest ranking ad source according to the second priority policy, excluding the first ad source (block 97) where the “first ad source” is the source from which the ad was requested at block 94. The process determines whether a usable ad is received from the second ad source (block 98). If an acceptable ad is received, then it is stored in the silo (block 99). If an acceptable ad is not received, then the process can repeat as indicated at block 101 for specified number of times. According to the process shown in FIG. 8, after storing an ad in the silo at block 96 and 99, the algorithm determines whether more ads are needed for filling the silo according to management parameters set up by the ad manager (block 100). If more ads are needed, then the process returns to block 94 to repeat the silo filling process. If no more ads are needed, then the algorithm ends (block 102).

The table below is an example of the ad source rankings for the first and second priority policies, the first priority policy imposing a preference for ad sources having better fill rate performance, and the second priority policy imposing a preference for ad sources having better performance in delivering value to the publisher. Thus, for the first priority policy, Ad Source 1 having the highest fill rate of 90% is the highest ranking ad source, while Ad Source 3 having the lowest fill rate of 40% is the lowest ranking ad source. However, for the second priority policy the priority policy ranking is based on the effective cost per thousand ad impressions (eCPM), which is the revenue the publisher receives from each ad network per thousand ads provided by the ad network. Thus, for the second priority policy, Ad Source 2 having the highest eCPM of 12 is the highest ranking ad source, while Ad Source 3 having the lowest eCPM of 6 is the lowest ranking ad source.

| | | eCPM | First Priority | Second Priority |
|---|---|---|---|---|
| Ad Source | Fill Rate (%) | ($/k) | Policy Ranking | Policy Ranking |
| Ad Source 1 | 90 | 10.00 | 1 | 2 |
| Ad Source 2 | 60 | 12.00 | 2 | 1 |
| Ad Source 3 | 40 | 6.00 | 3 | 3 |

The first priority policy imposing a preference for ad sources having better fill rate performance provides for delivery of ads with lowest available latency during the first part of a session with a mobile client. The second priority policy imposing a preference for ad sources having better performance in delivering value to the publisher, with the use of the ad data silos, for delivery of better quality ads with low latency in a later part of the session with the mobile client, improves the effectiveness of advertisements presented by the publisher.

In alternative embodiments, the rules for which ad sources to request ads from may be weighted on a percentage basis rather than an absolute ranking of the ad sources as discussed above. The table below is an example of such a weighting. In such an embodiment, the first priority policy is skewed to higher fill rates, while the second priority policy is skewed to higher eCPM. Thus, in this example the first priority policy will first request an ad from Ad Source 1 80% of the time, while the second priority policy will request an ad from Ad Source 2 75% of the time. In yet other alternative embodiments, one of the priority policies may be percentage based while the other may based on an absolute ranking of the ad sources.

| | Fill Rate | eCPM | First Priority | Second Priority |
|---|---|---|---|---|
| Ad Source | (%) | ($/k) | Policy Percentage | Policy Percentage |
| Ad Source 1 | 90 | 10.00 | 80 | 15 |
| Ad Source 2 | 60 | 12.00 | 15 | 75 |
| Ad Source 3 | 40 | 6.00 | 5 | 10 |

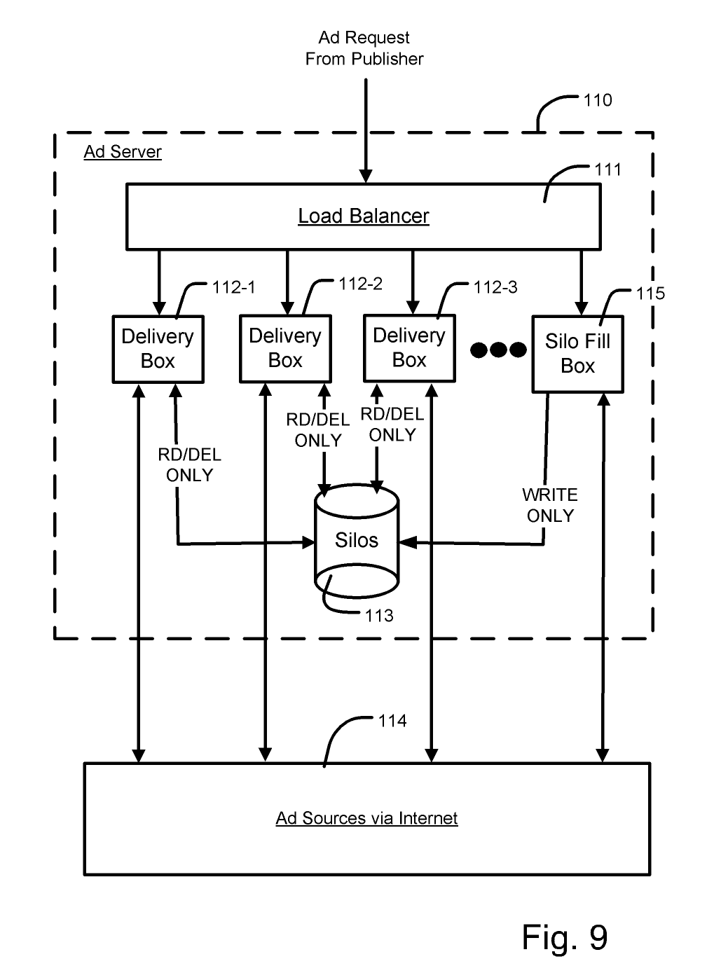

FIG. 9 is a simplified diagram of a network server system implementing an ad server 110 including the optimizing ad manager described herein using a load balancer 111. An ad request from the publisher is received by the load balancer 111 and delivered to one of a plurality of delivery boxes 112-1, 112-2, 112-3, . . . , where there can be any number of delivery boxes as needed. The delivery boxes 112-1, 112-2, 112-3, . . . can be implemented as programs on independent processors which have separate access to ad sources 114 using the Internet or other communication links. The delivery boxes 112-1, 112-2, 112-3, . . . can share access to the ad data silos 113 so that multiple requests in a series of requests from a given publisher can be handled by different delivery boxes 112-1, 112-2, 112-3, . . . in order to ensure efficient service by the system. Each delivery box in the plurality of delivery boxes 112-1, 112-2, 112-3, . . . can include all the resources discussed above for management of delivering ads to the requesters, by making requests to ad sources 114 according to the first priority policy used for delivery of low latency ads bypassing the silos 113, and reading and deleting ads in the ad silos. A silo fill box 115 or a set of silo fill boxes is included that cooperates with the delivery boxes 112-1, 112-2, 112-3 . . . to initiate communication with the ad sources 115 according to the second priority policy used for filling the silos 113. The silo fill box 114 or boxes can be configured to have write only access to the ad silos, to control shared access to the resource. Other load balancing configurations can be utilized as well.

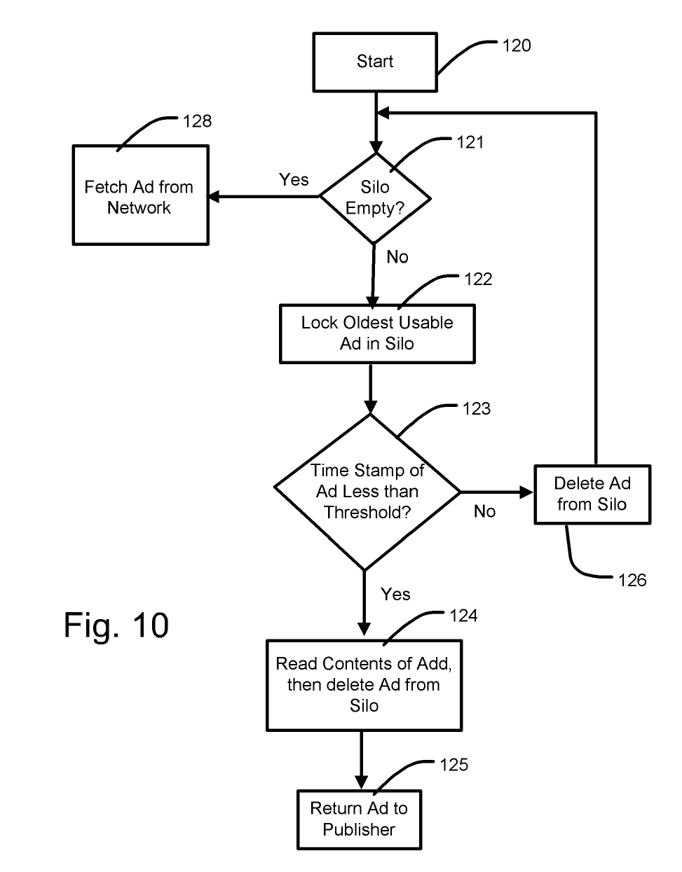

In an environment as shown in FIG. 9, a process such as that shown in FIG. 10 can be used to manage access to the silos by multiple delivery boxes. Thus, a process used by a given delivery box starts at block 120. The process determines whether the particular silo is empty such that it does not contain files that include current available ads (block 121). If the silo is empty, then the delivery box performs a protocol for fetching an ad from the network as discussed above (block 128). If the silo is not empty, then the delivery box will lock the oldest ad in the silo using an atomic operation (block 122). The delivery box will then determine whether the timestamp associated with the locked ad is less than a threshold which is set up to ensure that only fresh ads are utilized (block 123). If the locked ad is too old, then the ad is deleted from the silo (block 126) and the process returns to block 121. If the timestamp indicates that the ad remains fresh, then the contents of the file are read and the file can be deleted from the silo (block 124). The ad is then returned to the publisher (block 125). The delivery box also signals the silo fill box 115, which initiates a silo fill request as described above.

The architecture is operable for low latency, high quality ad serving in a WAP environment, in an ad-supported SMS environment, and in a manner in which the architecture can be integrated into the mobile wireless networks such as the endemic carrier-WAP infrastructure. These environments vary in terms of the presence of aggregators in an SMS and/or MMS environment that can be positioned in the communication path between the publishers and the ad manager, and in the presence of wireless network service providers that can be in the communication paths between the publishers and the ad manager, and between the consumers and the publishers for example. Also, in performance monitoring, the SMS message replies can be tracked based on keywords and the like, and based on call backs caused by clicks on embedded links, and on WAP click-throughs to links embedded in the publisher's message that carries the ad.

The architecture described herein improves ad serving latency, fill rates, targeting and click rates. It simplifies management, reduces operations and lowers ad technology costs. Furthermore, it provides end-to-end metrics and transparency with ad performance improvements. Using a neutral platform for connecting advertisers, ad networks and mobile publishers, dynamic optimization of the best performing ad inventory is delivered.

The technology facilitates multi-network ad sourcing, ad network contract optimization and ad network auditing tools. The architecture can apply ad analytics, user analytics and can take advantage of outsourced operations for optimization processes. It also enables input relating to campaign management by advertisers. The system is able to optimize the impressions delivered to the customer while improving revenue for the publisher. The system reduces latency while providing ad network aggregation, predictive caching, better targeting, intelligent prioritization, and flexible direct campaign management. The architecture is adapted for delivering the best effective CPM to the ad networks.

These processes are capable of managing multiple simultaneous advertisers and multiple simultaneous campaigns with prioritization in relation to ad networks and other campaigns, scheduling, pausing, deleting, application of business rules including campaign value, impressions/click/frequency capping, and providing revenue tracking in the form of CPC, CPM and monthly spend rates.

The architecture is capable of managing an ad network across multiple protocols, including SMS, MMS, WAP banner, WAP text link, and embedded application “In-App” ads. The system provides active management of the advertising ecosystem relationships while allowing human oversight and tuning.

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A method for fulfilling ad requests for delivery of ads from a plurality of ad sources to mobile clients in a mobile network, comprising:
maintaining ad data silos for ad requesters accessible to a network server system, organized according to selected characteristics of mobile clients of the ad requesters;
in response to an incoming request from an ad requester for delivery of an ad, attempting to fulfill the incoming request by performing at least one of (1) retrieving an ad from a corresponding ad data silo to fulfill the incoming request, and (2) retrieving an ad according to a first priority policy from an ad source among the plurality of ad sources to fulfill the incoming request by executing processes in the network server system; and
in response to the incoming request or other signals predictive of a request by the ad requester, retrieving an ad according to a second priority policy from an ad source among the plurality of ad sources to store in the corresponding ad data silo by executing processes in the network server system.

2. The method of claim 1, wherein said attempting to fulfill the incoming request includes:
parsing the incoming request for delivery of an ad to identify characteristics of a mobile client associated with the incoming request to identify the corresponding ad data silo;
walking the corresponding ad data silo to find a usable ad, and returning the usable ad to fulfill the request;
composing a first request for retrieval of an ad according to the first priority policy from an ad source among the plurality of ad sources, and transmitting the first request;
receiving a response to the first request, and returning an ad contained in the response to fulfill the request if a usable ad was not returned from the ad data silo; composing a second request for retrieval of an ad from an ad source among the plurality of ad sources selected according to the second priority policy, and transmitting the second request; and
receiving a response to the second request, and storing an ad contained in the response to the second request to the corresponding ad data silo, wherein an interval of time from said composing a first request to receiving a response to the first request overlaps in time with an interval of time from said composing a second request to receiving a response to the second request.

3. The method of claim 2, wherein said transmitting the first request is executed only if said walking the corresponding ad data silo does not find a usable ad.

4. The method of claim 2, wherein said transmitting the second request is executed independent of whether or not said walking the corresponding ad data silo finds a usable ad.

5. The method of claim 1, further comprising tracking performance of ads returned in fulfillment of the incoming requests, and updating the second priority policy based on said performance.

6. The method of claim 5, wherein said monitoring performance includes tracking at least one of latency between an ad request and fulfillment of the ad request by ad sources, impressions of ads from ad sources, banner image requests, click-through rate for ad sources and effective revenue rate for the ad requester.

7. The method of claim 1, further comprising tracking performance of ads returned in fulfillment of the incoming requests, and updating the first and second priority policies based on said performance.

8. The method of claim 1, wherein said first priority policy imposes a preference for ad sources having better fill rate performance, and the second priority policy imposes a preference for ad sources having better performance in delivering value to the ad requester.

9. The method of claim 1, wherein said retrieving an ad from the corresponding ad data silo includes selecting an ad from the corresponding ad data silo based on a length of time that the ad has been stored.

10. The method of claim 1, including removing ads from particular ad data silos if a length of time that the ad has been stored in the corresponding ad data silo exceeds a time limit.

11. The method of claim 1, including associating tags with ads stored in ad data silos with characteristics of intended mobile clients, and wherein said retrieving an ad from the corresponding ad data silo includes selecting an ad based on said tags.

12. The method of claim 1, including providing a software module to ad requesters which configures ad requests with parameters for identifying corresponding ad data silos.

13. The method of claim 1, including instrumenting ads returned to fulfill the incoming request for performance monitoring.

14. The method of claim 1, including maintaining a metric associated with a particular ad data silo indicating a number of ad requests per session, and determining whether to retrieve an ad according to the second priority policy from an ad source among the plurality of ad sources to store in the particular ad data silo in response to a particular ad request based on said number.

15. The method of claim 1, including for mobile web pages having two ads, responding to an incoming request for delivery of two ads from an ad requester for a mobile web page, by retrieving one of the two ads according to the first priority policy from an ad source among the plurality of ad sources, and retrieving another of the two ads according to a modified first priority policy to fulfill the incoming request for two ads.

16. A data processing system for fulfilling ad requests for delivery of ads from a plurality of ad sources to mobile clients in a mobile network, comprising:
a plurality of ad data silos for respective ad requesters, organized according to selected characteristics of mobile targets; and
an ad manager including data processing resources which in response to an incoming request from an ad requester for delivery of an ad, attempts to fulfill the request, by executing processes including:
performing at least one of (1) retrieving an ad from a corresponding ad data silo to fulfill the incoming request, and (2) retrieving an ad according to a first priority policy from an ad source among the plurality of ad sources to fulfill the incoming request, and
maintaining said plurality of ad data silos, including and in response to the incoming request or other signals predictive of a request by the ad requester, retrieving an ad according to a second priority policy from an ad source among the plurality of ad sources to store in the corresponding silo.

17. The data processing system of claim 16, wherein the ad manager comprises:
processing resources which parse the incoming request for delivery of an ad to identify characteristics of a mobile client associated with the incoming request to identify the corresponding ad data silo;
processing resources which walk the corresponding ad data silo to find a usable ad, and if a usable ad is present, return the usable ad to fulfill the request;
a first priority engine which in response to the incoming request, composes a first request for retrieval of an ad according to the first priority policy from an ad source among the plurality of ad sources, transmits the first request, and receives a response to the first request, and if a usable ad is contained in the response, returns the usable ad to fulfill the request; and
a second priority engine which in response to the incoming request, composes a second request for retrieval of an ad according to the second priority policy from an ad source from among the plurality of ad sources, transmits the second request, receives a response to the second request, and stores an ad contained in the response to the corresponding ad data silo.

18. The data processing system of claim 16, further comprising data processing resources which perform ad tracking to track performance of ads returned in fulfillment of the incoming requests, and updating the second priority policy based on said performance.

19. The data processing system of claim 18, wherein said data processing resources which perform ad tracking to track performance include logic for tracking at least one of latency between an ad request and fulfillment of the ad request by ad sources, impressions of ads from ad sources, banner image requests, click-through rate for ad sources and effective revenue rate for the ad requester.

20. The data processing system of claim 16, further comprising data processing resources which perform ad tracking to track performance of ads returned in fulfillment of the incoming requests, and updating the first and second priority policies based on said performance.

21. The data processing system of claim 16, wherein said first priority policy imposes a preference for ad sources having better fill rate performance, and the second priority policy imposes a preference for ad sources having better performance in delivering value to the ad requester.

22. The data processing system of claim 16, wherein said data processing resources execute said retrieving an ad according to a first priority policy only if a usable ad is not retrieved from the corresponding ad data silo.

23. The data processing system of claim 16, wherein said data processing resources execute said retrieving an ad according to a second priority policy independent of whether or not a usable ad is retrieved from the corresponding ad data silo.

24. The data processing system of claim 16, wherein in retrieving an ad from the corresponding ad data silo to fulfill the incoming request, said data processing resources select an ad from the corresponding ad data silo based on a length of time that the ad has been stored.

25. The data processing system of claim 16, including data processing resources to remove ads from plurality of the ad data silos if a length of time that the ad has been stored there exceeds a time limit.

26. The data processing system of claim 16, including data processing resources to tag ads stored in the plurality of ad data silos with characteristics of intended mobile clients, and wherein in retrieving an ad from the corresponding ad data silo to fulfill the incoming request, said data processing resources select an ad from the corresponding ad data silo based on said characteristics.

27. The data processing system of claim 16, including logic to provide a software module to ad requesters executable to configure ad requests with parameters for identifying corresponding ad data silos.

28. The data processing system of claim 16, including resources to instrument ads returned to fulfill the incoming request for performance monitoring.

29. The data processing system of claim 16, including resources to maintain a metric associated with a particular ad data silo indicating a number of ad requests per session, and to determine whether to retrieve an ad according to the second priority policy from an ad source among the plurality of ad sources to store in the particular ad data silo in response to a particular ad request based on said number.

30. The data processing system of claim 16, including resources that respond to an incoming request for delivery of two ads from an ad requester for a mobile web page, by retrieving one of the two ads according to the first priority policy from an ad source among the plurality of ad sources, and retrieving another of the two ads according to a modified first priority policy to fulfill the incoming request for two ads.

31. An article of manufacture comprising a machine readable data storage medium, and computer programs stored thereon, that are executable for fulfilling ad requests from a plurality of ad sources to mobile clients in a mobile network, the computer program comprising:
logic that maintains ad data silos for ad requesters, organized according to selected characteristics of mobile clients of the ad requesters;
logic that, in response to an incoming request from an ad requester for delivery of an ad, attempts to fulfill the incoming request by performing at least one of (1) retrieving an ad from a corresponding ad data silo to fulfill the incoming request, and (2) retrieving an ad according to a first priority policy from an ad source among the plurality of ad sources to fulfill the incoming request; and
logic that, in response to the incoming request or other signals predictive of a request by the ad requester, retrieves an ad according to a second priority policy from an ad source among the plurality of ad sources to store in the corresponding ad data silo.
